(19) United States
(12) Patent Application Publication
(10) Pub. No.: US 2017/0154343 A1
(43) Pub. Date: Jun. 1, 2017

(54) Counterfeit Product Detection and Content Management System

(71) Applicant: Universal Product Registration Corporation, Glendale Heights, IL (US)

(72) Inventors: Kevin M. Kozlowski, Wheaton, IL (US); Andrew G. Rachmiel, Park Ridge, IL (US)

(73) Assignee: Universal Product Registration Corporation

(21) Appl. No.: 15/365,448

(22) Filed: Nov. 30, 2016

Related U.S. Application Data
(60) Provisional application No. 62/260,719, filed on Nov. 30, 2015.

(51) Int. Cl. G06Q 30/00; G06K 19/06

(52) U.S. Cl. CPC G06Q 30/0185; G06K 19/06037; G06K 19/06028

(57) ABSTRACT

A counterfeit product detection and content management system includes: a physical identifier affixed to a product, the identifier including an organization identifier, product identifier, serial identifier, and parity check identifier; a mobile device including a physical identifier reader and a communications subsystem; and a server in communication with the mobile device and in communication with a database storing a plurality of product verification records, each product verification record including an organization identifier, product identifier, serial identifier, and parity check identifier; wherein, in response to the server receiving a communication of the physical identifier from the mobile device, the server determines whether the organization identifier, the product identifier, the serial identifier, and the parity check identifier match one of the stored product verification records in the database and, when the server determines there is no match, the server communicates to the mobile device that the product is counterfeit.

### CROSS-REFERENCE TO RELATED APPLICATIONS

This application incorporates by reference and claims the benefit of priority to U.S. Provisional Patent Application No. 62/260,719 filed Nov. 30, 2015.

### BACKGROUND OF THE INVENTION

The present subject matter relates generally to a system for detecting counterfeit products and providing content associated with the product. More specifically, the present invention relates to a counterfeit product detection and content management system that permits users to utilize a unique identifier provided with the product to verify authenticity and access content associated with the product.

Brands and manufacturers lose revenue each year due to fake product sales. Counterfeiting also impacts brand perception and value as the quality of counterfeits doesn't compare to the original product.

Globalization and eCommerce continue to grow in scale and impact, as does the sophistication of counterfeiting operations. As a result, brand owners and manufacturers face significant challenges. For example, knockoff's tarnish the brand's reputation and devalue the investment. Imitation products are often difficult to distinguish from the genuine product. Fakes often use cheap materials or leave some out altogether. There is generally a lack of quality control when manufacturing counterfeits.

Counterfeit products are difficult for manufacturers to detect as few products are ever registered and there is no downstream data about products after they are sold. This creates a big problem, especially in the area of safety related products where a counterfeit product may fail to properly perform in the event it is needed.

Successful detection of counterfeiting can take years, and by then damage may be done to a business. Unless products are registered or somehow tracked, manufacturers have very little visibility into and contact with downstream stakeholders and where products are physically located. As a result, it is very difficult to proactively address any product recalls or similar issues and offer reliable support for product servicing (e.g., updated product manuals and replacement parts). Thus, there is a need for manufacturers to track such information and cease relinquishing the end-user customer relationship to frontline stakeholders.

Additionally, manufacturers have a difficult time tracking whether a finished piece or good properly ships versus one that “disappears”, is stolen, or is otherwise sold in a manner not approved by the manufacturer. Thus, there is a need of a mechanism for loss detection of pieces of products that are sold outside of manufacturer-controlled channels.

Even when products are sold into the correct channels, there is generally no way for retailers to make sure a product is genuine and has not been registered at the point of sale. This exposes retailers to the risk of stocking products that may not be genuine as they may have little to no way to know if a given product is a counterfeit or if the product they are selling is authorized to be sold via their sales channel (e.g., an authorized seller is selling through an unauthorized manner such as an online marketplace).

As a result, manufacturers maintain high exposure as there is no global, agnostic way to detect and prevent counterfeits from entering the market.

It's not possible to prevent counterfeits from being made. With this invention, it is now possible to dramatically decrease the amount of time between counterfeits entering the market, becoming aware that they exist, and reversing the supply chain to discover and terminate the root source.

As well, many manufacturers lack a systematic way to support their customers or alert them to important product recalls and service bulletins. Customers currently search across the internet to find replacement parts and service needs, often finding outdated or incorrect information.

Manufacturers also have a difficult time identifying the source of authentic products being sold in unsanctioned channels such as on ecommerce websites that were not authorized (i.e. the grey market).

Additionally, because manufacturers may not have a direct relationship with their ultimate users, they often have difficulty transmitting appropriate product information to the correct parties. Service technicians and other third parties (e.g., consumers) often have difficulty accessing up-to-date manuals and other information in the field for a product. For service technicians, there is often no audit trail of a product's lifecycle or service history, especially when various companies touch the product.

As for consumers, there is currently no widely accepted central system to manage all product purchases and/or registrations, and there is often little to no benefit to use the current systems that exist, such as mail in cards or website forms. This is an issue because, for end users of products that need regular inspection and/or service, it is difficult to know what needs to be done in order to comply with applicable laws as well as keep up with the needs of a specific product. Also, for these users, product registration materials that are not in an easily accessible, known, central location make product details cumbersome to track. Such obstacles make tasks like asset tracking a daunting task for companies of any scale as it is hard to monitor who has what hardware and where it is located.

Retailers can be exposed by stocking products that may not be genuine, and they have limited ability to know or detect if a product is a counterfeit.

Previous solutions to the counterfeiting problem have included using unique and hard to graphically reproduce stickers and labels. The goal of these solutions was to prevent others from copying the decal by providing a designation so unique it could not be replicated. However, with wide spread advancements in printing technology, this strategy has often become ineffective.

Accordingly, there is a need for a counterfeit product detection and content management system that provides a global solution that prevents counterfeit products from entering the market, along with managing all of the various touches that occur over the product's lifecycle, as described herein.

### BRIEF SUMMARY OF THE INVENTION

To meet the needs described above and others, the present disclosure provides a counterfeit product detection and content management system (“counterfeit detection and content management system”) that utilizes a product identifier/verification identifier (“identifier”) associated with (or attached to) a product (i.e., piece) used to identify authenticity, improve customer service and the customer experience through self-service access to service bulletins, recalls, product information and other critical information, and provide a means for tracking interactions with the product itself.

A user may access the identifier using any number of devices having the ability to read and retrieve information from the identifier. For example, the identifier may be embedded into a 2-dimensional or 3-dimensional object such as a QR Code where any computing device, such as a mobile device running a QR Code reader, could scan the identifier to access to access the counterfeit detection and content management system.

The counterfeit detection and content management system may be a cloud-based content management solution that addresses counterfeit products entering the market, product registration, and provides a one-stop access to product literature, alerts/recalls, etc.

The counterfeit detection and content management system may also provide a bridge between objects containing the identifier and applications needing to retrieve information about the object, such as product literature, service history, etc.

The counterfeit detection and content management system may utilize a unique and non-replicable identifier that is embodied in (e.g., encoded upon, printed on, etc.), affixed to, and associated with each piece of a product produced by a manufacturer. In a preferred embodiment, the identifier is used to: activate the product in the system prior to leaving the manufacturer's facility; determine the authenticity of the product once it has left the manufacturer's facility; register the product and its geolocation coordinates as it moves towards and arrives at its final destination; and provide information and analytics to the user of the system.

By playing a role in product activation of a piece, the counterfeit detection and content management system may further assist in loss detection. For example, if a product is removed from the manufacturer improperly, the manufacturer may be notified of the inactivated product at the time it is checked for authenticity.

Alternatively, when a product that has been properly activated by the manufacturer is accessed by a user to confirm authenticity, the system takes one of two actions. First, if the piece was activated by the manufacturer but not yet registered, it may be registered. Logistic information, such as who scanned the piece, where it was scanned, at what time it was scanned, etc., may be captured from the scanning device. Once the product has been activated and registered, the system may provide additional functionality, such as recording and scheduling inspections of the piece, recording and scheduling repairs of the piece, access to a service history of the piece, etc.

When a piece is scanned for a second time and onward (e.g., each time after the first post activation scan), the system may determine whether the piece has been accessed by the same device in the past or if it remained within a predetermined distance from the geolocation coordinates at which it was last scanned or registered. If the piece is outside of a predetermined distance from those geolocation coordinates, the system may alert the user that the piece may be counterfeit.

Other embodiments of the present invention may include systems and methods for verifying the authenticity of a product in which, in a first step, an authentication server receives information included within a unique identifier including, but not limited to, an identification number representing the manufacturer of the object, an identification number representing the product number of the object, an identification number representing the serial number of the object, and a randomly generated string unique to that combination (“parity check”). The authentication server then records the information as a record in an underlying database, including the information contained within the unique identifier, the date and time the identifier was accessed, the geolocation coordinates of where the identifier was accessed and other information about the device that was used to access the identifier. After this, in response to receiving, by the authentication server, the information is compared against the information in the system's database to determine if there is an exact match, and if so, has the identifier been activated within the system.

In the event that the identifier has not been activated within the system and the device used to access the identifier is used to activate the identifier in the system, the authentication server responds to the request with a message indicating that the product is activated and a database record is created or modified indicating the activation. If the identifier has been activated within the system and the device used to access the identifier is used to activate the identifier in the system, the authentication server responds to the request with a message indicating that the product has been previously activated.

If the device used to access the identifier is not one used for the purpose of activating the identifier, the method described above proceeds based on whether the identifier has been flagged as counterfeit or not. In the event that the identifier has been flagged as counterfeit, the authentication server responds to the authentication request with a message indicating that the product is counterfeit, the manufacturer is notified accordingly, and a database record is created or modified indicating the result.

In the event that the identifier has not been flagged previously as counterfeit, the system and method determines whether the identifier has been previously activated by the manufacturer. If it has not, the authentication server responds to the activation request with a message indicating that the product has not been activated, the manufacturer is notified accordingly, and a database record is created or modified indicating the result. If it has been previously activated, the activation server determines whether the device being used to access the identifier has been previously used to access the exact identifier in the past.

In the event that the device has been previously used, the authentication server responds to the request with a message indicating that the product is authentic and a database record is created or modified indicating the result. In the event that the device has not been previously used, the authentication server determines whether the identifier has been accessed by any device in the past.

In the event that the identifier has not been previously accessed, the authentication server responds to the request with a message indicating that the product is authentic and a database record is created or modified indicating the result. In the event that the identifier has been previously accessed, the authentication server compares the geolocation coordinates of the device accessing the identifier with the geolocation coordinates of the device(s) accessing the identifier in the past to determine whether it is less than or greater than a predetermined distance allowed by the manufacturer.

In the event that the distance is less than or equal to the predetermined distance allowed by the manufacturer, the authentication server responds to the request with a message indicating that the product is authentic and a database record is created or modified indicating the result. If not, the authentication server responds to the authentication request with a message indicating that the product is counterfeit, the manufacturer is notified accordingly, and a database record is created or modified indicating the result.

The system and method above may also be used to retrieve product information from a content management system in the event that the identifier is determined to be authentic.

In one example, a counterfeit product detection and content management system or method includes: a physical identifier affixed to a product, the physical identifier including an organization identifier, a product identifier, a serial identifier, and a parity check identifier; a mobile device including a physical identifier reader and a communications subsystem; and a server in communication with the mobile device and in communication with a database storing a plurality of product verification records, each product verification record including a stored organization identifier, a stored product identifier, a stored serial identifier, and a stored parity check identifier; wherein, in response to the server receiving a communication of the physical identifier from the mobile device, the server determines whether the organization identifier, the product identifier, the serial identifier, and the parity check identifier match the stored organization identifier, the stored product identifier, the stored serial identifier, and the stored parity check identifier of one of the stored product verification records in the database and, when the server determines there is no match, the server communicates to the mobile device that the product is counterfeit.

The physical identifier may be encoded in a URL. The URL may be encoded in one of a QR code, a bar code, and an RFID chip. The URL may include the organization identifier, the product identifier, the serial identifier, and the parity check identifier. However, it is understood that the physical identifier need not be embodied in a URL encoded in a QR code, bar code, or RFID chip. Any identification that is physically associated with the product can function as the physical identifier as long as it is capable of communicating the four parameters to the server.

In some instances, at least one of the product verification records further includes a date and a time that the physical identifier was communicated to the server, and an IP address of the mobile device at the time the physical identifier was communicated to the server.

In further examples, when the server determines there is a match, the server determines if the matched product verification record includes a counterfeit flag and, when the server determines there is a counterfeit flag, the server communicates to the mobile device that the product is counterfeit. When the server determines there is no counterfeit flag, the server communicates to the mobile device that the product may be authentic.

In still further examples, the server requests geolocation coordinates of the mobile device at the time the physical identifier is communicated to the server, and if allowed, updates geolocation coordinates in the matched one of the stored product verification records. When the server determines the physical identifier has previously been communicated to the server, the server communicates to the mobile device that the product is authentic. When the server determines the physical identifier has previously been communicated to the server by any mobile device, the server determines whether the physical identifier has previously been communicated to the server by the same mobile device. When the server determines that the physical identifier has been previously communicated by the mobile device, the server communicates to the mobile device that the product is authentic. When the server determines that the physical identifier has not been previously communicated to by the same mobile device, the server compares the geolocation coordinates being communicated to the server to any previously stored product verification records for the physical identifier and, if a distance between geolocation coordinates in the stored product verification record and the geolocation coordinates being communicated to the server are greater than a predetermined allowable distance, the server communicates to the mobile device that the product is counterfeit. When the server determines that the physical identifier has not been previously communicated to by the same mobile device, the server compares the geolocation coordinates being communicated to the server to any previously stored product verification records for the physical identifier and, if a distance between geolocation coordinates in the stored product verification record and the geolocation coordinates being communicated to the server are less than or equal to a predetermined allowable distance, the server communicates to the mobile device that the product is authentic.

In some examples, when the server determines the physical identifier has not been previously communicated to the server, it requests registration of the product through the mobile device.

The parity check identifier may be a randomly generated string of characters.

An object of the invention is to provide a solution to the problem of detecting counterfeit goods. The present solution modernizes the antiquated anti-counterfeiting technique of printing unique labels on goods by combining such technology with a computerized cloud based system which can monitor metadata (e.g., item's origin, current location, manufacturer, etc.) about goods and close the feedback loop concerning downstream distribution and use of a good.

An advantage of the invention is that it provides a mechanism for loss detection of product that is sold outside of manufacturer-controlled channels. With current anti-counterfeiting systems, once a product leaves a manufacture's facility, the product may be lost, stolen, or sold without permission. The present system constantly monitors products and can detect unauthorized sales based off an items location, number of times an item has been scanned, etc.

Another advantage of the invention is that it provides mechanisms to track the service history of a product or good. Currently, manufactures do not have a consistent, computerized method of tracking the install, service, or decommissioning of a product. For example, if there is a service recall on a tractor, most manufactures would contact distributors who in turn would contact consumers and attempt to recall the product. However, once the tractors are repaired and sent back out to consumers, there is no current system for consumers to quickly verify if the issue leading to the recall on a particular tractor has been resolved or if there are any other outstanding service recalls for a given tractor. The present system rectifies this by providing a cloud based system which assigns a unique identifier to each product and also tracks metadata concerning the product to ensure service history, etc. are easily accessible. Additionally, the system alerts users if their product has been scanned by someone else or at another geographical location, tipping system user's off that there may be counterfeit activity.

A further advantage of the invention is that it provides authentication of a product to permit a user to be reassured that a product is genuine. As mentioned above, the system utilizes metadata about a given product or good to ensure the product was appropriately manufactured, is in the location it is expected to be in, serviced where it is expected to be serviced, etc. This allows consumers to have a safety net and to buy with confidence.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic showing an example of a counterfeit product detection and content management system for using a mobile device to communicate with a counterfeit detection system to authenticate a unique identifier, or a web browser to communicate with a counterfeit detection and content management system to administer the system.

FIG. 2 is an example mobile device accessing the counterfeit detection system of the system of FIG. 1

FIG. 3 illustrates example counterfeit detection and content management servers of the counterfeit detection and content management system of FIG. 1.

FIG. 4 is a flowchart of the counterfeit detection and content management system of FIG. 1 operating once an identifier has been activated.

FIG. 5 is a flowchart of the counterfeit detection and content management system of FIG. 1 operating before an identifier has been activated.

FIG. 6 is a flowchart of the counterfeit detection and content management system of FIG. 1 operating after an identifier has been activated displaying the content management component.

FIG. 7 is a flowchart of the counterfeit detection and content management system of FIG. 1 operating after an identifier has been activated displaying a sampling of actionable items that are available.

FIG. 8 is a flowchart of an example of the steps of generating authentication information for an identifier used by the counterfeit detection and content management system.

FIG. 9 is a chart illustrating an example of a product verification record stored in the database of the system of FIG. 1.

FIG. 10 illustrates an example interface for scanning an identifier (in this example represented as data within a QR Code) of a counterfeit detection and content management system embodying the counterfeit detection application of FIG. 1.

FIG. 11 illustrates an example interface for activating a product identifier of a counterfeit detection and content management system that is displayed when the identifier is correctly activated within the counterfeit detection application of FIG. 1.

FIG. 12 illustrates an example interface for activating a product identifier of a counterfeit detection and content management system that is displayed when the identifier does not exist within the counterfeit detection application of FIG. 1.

FIG. 13 illustrates an example interface for activating a product identifier of a counterfeit detection and content management system that is displayed when the identifier has been previously activated within the counterfeit detection application of FIG. 1.

FIG. 14 illustrates an example interface for registering a product identifier of a counterfeit detection and content management system that is displayed upon a successful registration within the counterfeit detection application of FIG. 1.

FIG. 15 illustrates an example interface for a product identifier within the counterfeit detection application of FIG. 1 that is displayed to warn a user of a potential counterfeit.

FIG. 16 illustrates an example interface for a product identifier within the counterfeit detection application of FIG. 1 that is displayed to allow various actions for an authentic identifier.

FIG. 17 illustrates an example interface for a product identifier within the counterfeit detection application of FIG. 1 that is displayed when a product may be authentic.

FIG. 18 illustrates an example interface for a product identifier within the counterfeit detection application of FIG. 1 that is displayed when a product is authentic.

FIG. 19 illustrates an example interface for a product identifier within the counterfeit detection application of FIG. 1 that displays links to various product information.

FIG. 20 illustrates an example interface for a product identifier within the counterfeit detection application of FIG. 1 that displays product recall information.

FIG. 21 illustrates an example interface for a product identifier within the counterfeit detection application of FIG. 1 that displays product service bulletin information.

### DETAILED DESCRIPTION OF THE INVENTION

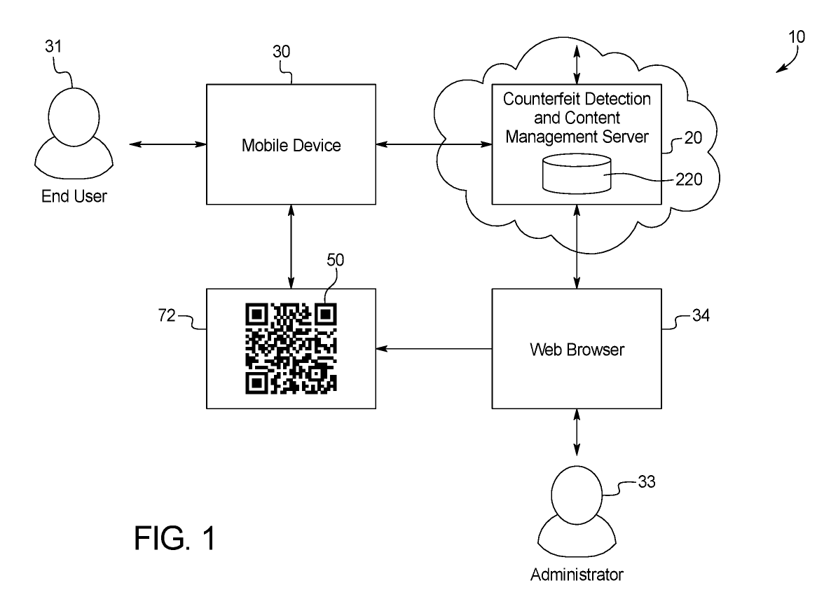

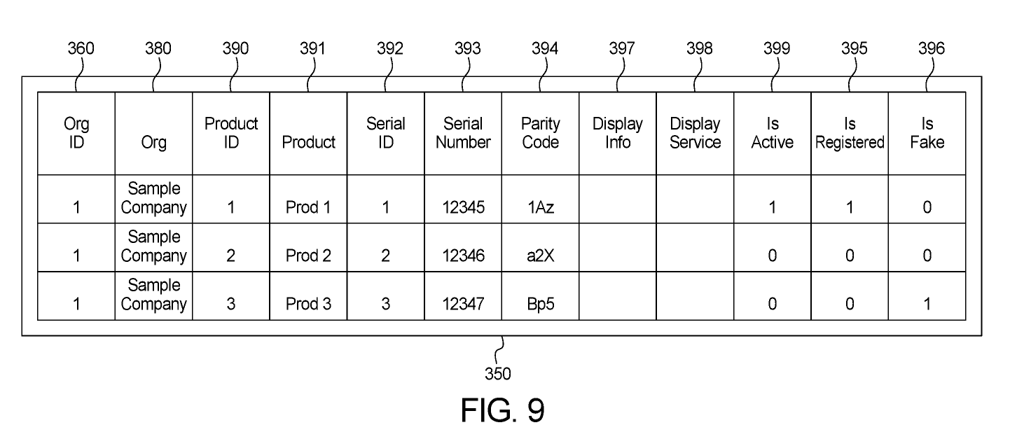

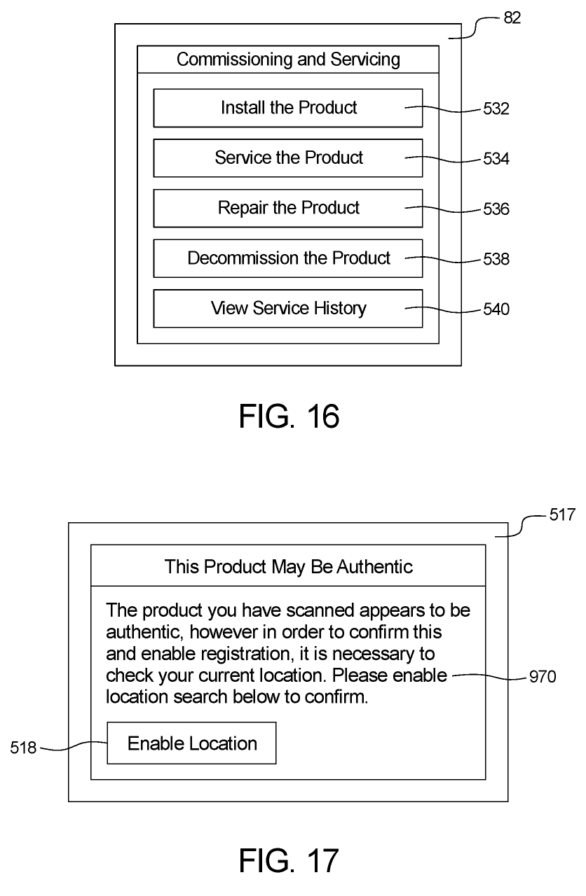

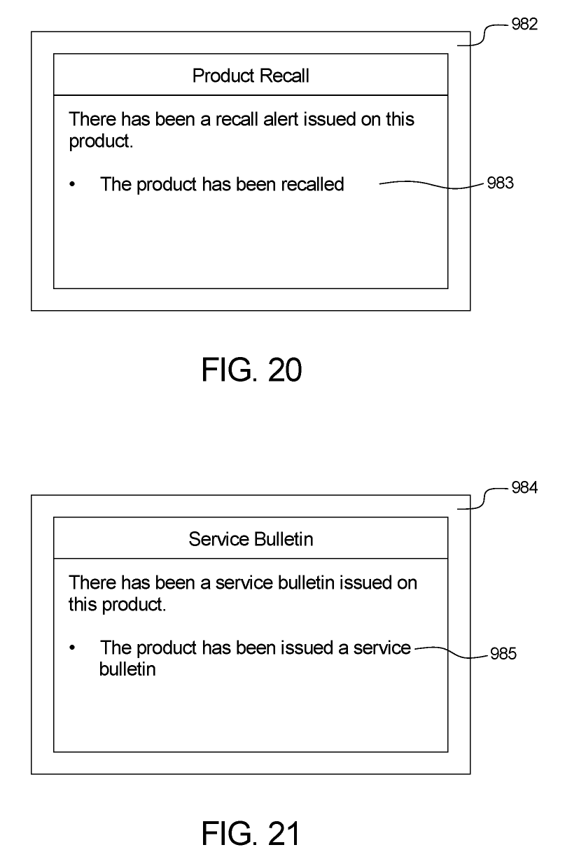

FIG. 1 illustrates an example of a counterfeit product detection and content management system (counterfeit detection and content management system 10). In the example shown in FIG. 1, the counterfeit detection and content management system 10 includes one or more cloud based counterfeit detection and content management servers 20. A user 31, using a mobile user device 30, may verify an identifier 50. In an embodiment, the user may use their mobile device 30 to read (for example scan) a physical identifier 50 affixed to a product via, for example, a label 72 including the identifier 50 to verify the authenticity of the product with which the identifier 50 is affixed. The identifier 50 bears information allowing it to communicate via the mobile device 30 with the counterfeit detection and content management servers 20 associated with a product verification record 350 (FIG. 9) stored in a database 220 of the counterfeit detection and content management servers 20. The mobile device 30 may transmit the information contained within the identifier 50 over the internet to the counterfeit detection and content management servers 20 that, in turn, may analyze the information to determine authenticity. The result of the authenticity analysis may then be transmitted back to the mobile device 30. Additionally, in response to the authentication request, the counterfeit detection servers 20 may provide the mobile device with access to product content 80 (FIG. 19), product recalls 81 (FIG. 20), service bulletins 82 (FIG. 21), and/or product service actions 82 (FIG. 16).

As additionally shown in FIG. 1, an administrator 33, using a web browser 34, may administer the counterfeit detection and content management system 10, as described herein.

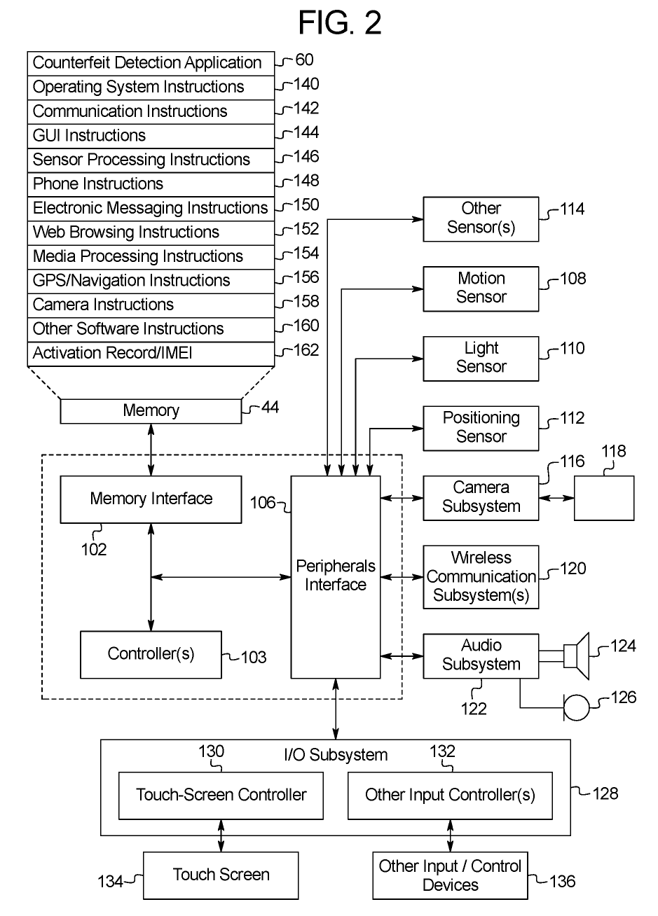

Turning to FIG. 2, the user device 30 may be a mobile device such as a smartphone, with the ability to interface with the identifier 50 and the counterfeit detection and content management system 10 to provide the functionality described herein. The user device 30 may include wireless communication subsystem 120 to communicate with one or more counterfeit detection and content management servers 20. In various embodiments, the counterfeit detection and content management servers 20 and the user devices 30 coordinate to carry out the functionality of the system 10. Accordingly, it will be apparent to those of skill in the art from the disclosure herein that functionality described herein for the users' devices 30 may, in some embodiments, be accomplished by the counterfeit detection and content management servers 20, and conversely, the functionality described herein for the chat server 60 may, in some embodiments, be accomplished by the user devices 30.

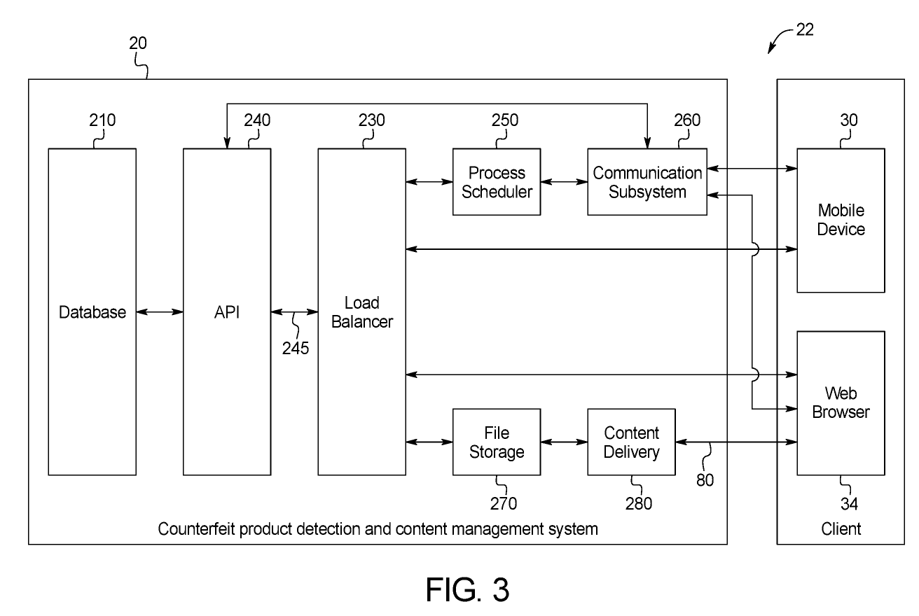

FIG. 3 illustrates the counterfeit detection and content management servers 20 of the counterfeit detection and content management system 10. As shown, the counterfeit detection and content management servers 20 may include various cloud-based software and hardware subsystems that interoperate to carry out the functionality of the counterfeit detection and content management system 10. For example, in the embodiment shown in FIG. 3, the counterfeit detection and content management servers 20 are built on top of cloud infrastructure 22. As shown, the counterfeit detection and content management server 20 may include load balancers 230 that receive API requests 240 from the counterfeit detection application 30 and a web application browser for administrators 34. The load balancers 230 may forward API requests 245 to API servers 240 that may act on the API requests 245. The API servers 240 may store and retrieve data from a database 210. A content delivery server 280 may deliver product content 80 from file storage servers 270. There may also be a process scheduler 250 which handles the communication subsystems 260 to send out alerts, such as, but not limited to, email or SMS messages.

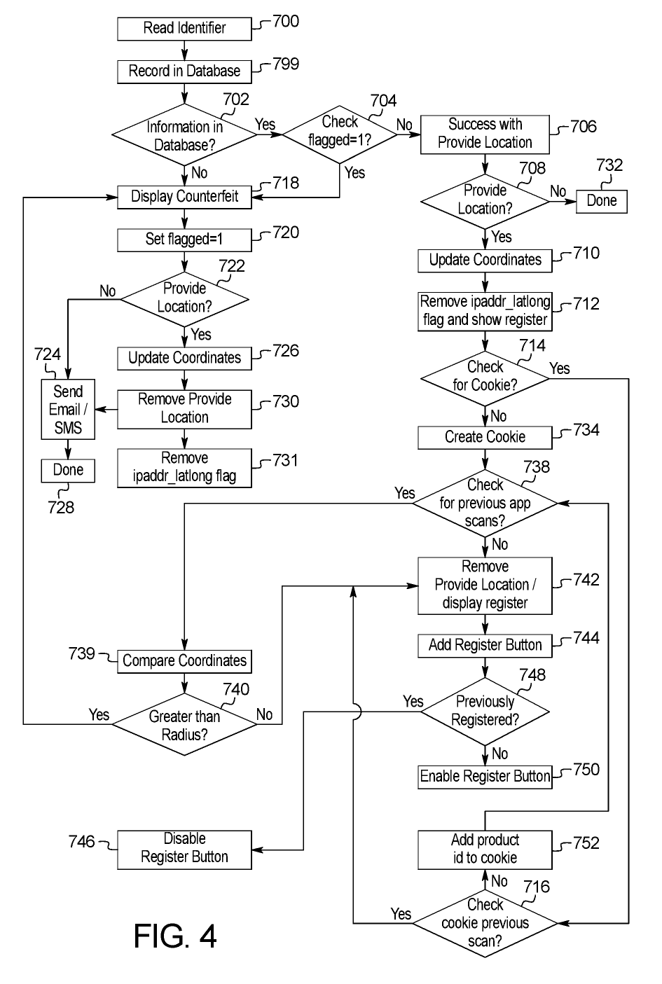

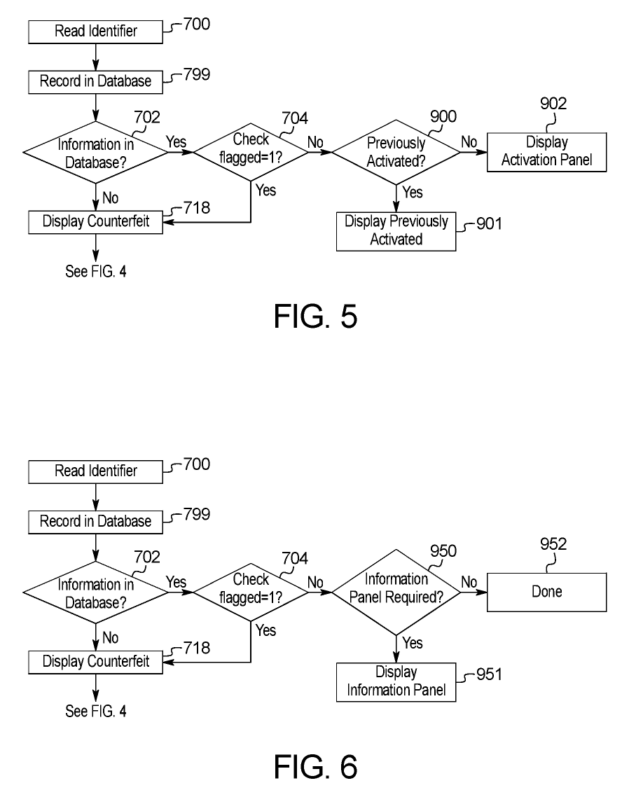

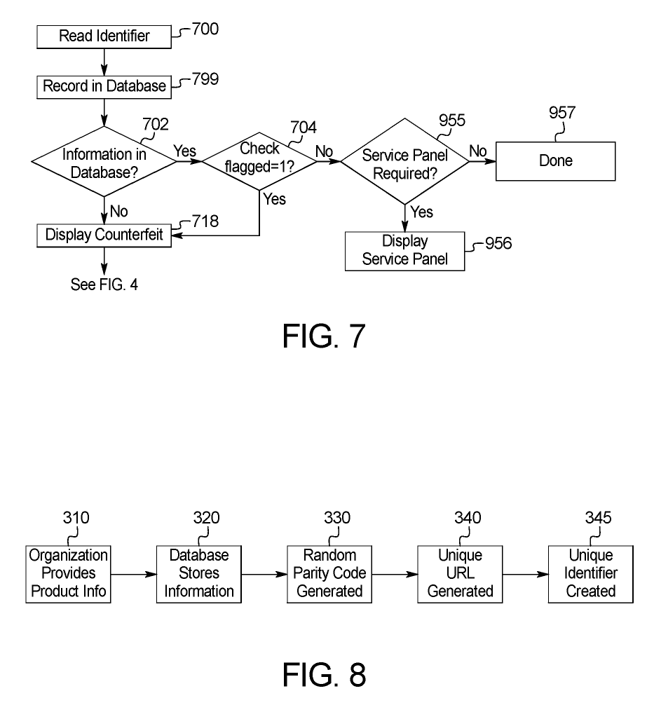

FIG. 4 is a flowchart of how the counterfeit detection and content management system 10 operates once an identifier 50 has been activated. As shown in FIG. 4, after an identifier 50 is active in the system 10, a user device 30 may read 700 a physical identifier 50 provided on a product label 72 using any device capable of reading and processing the identifier 50 (in one example a smart phone with a QR Code reader application that can read an identifier in the form of a QR Code), etc. Once retrieved, the system 10 records a new record 799 in a database 220 that includes, but is not limited to, the ID for the organization, product and serial number, the unique parity code, the data and time that the identifier 50 was read, the IP Address of the device used to read the identifier 50, and the geolocation coordinates based upon the IP Address of the device used to read the identifier 50.

The system 10 next checks the authentication data from the scanned identifier 50 now stored as a record 799 in the database 220 (FIG. 9) versus the product verification records 350 (FIG. 9) stored in a database 220 to check 702 whether there is a match. If the information in the record 799 does not match the product verification records 350, the system 10 sets a counterfeit flag 396 (FIG. 9) indicating that the identifier is counterfeit 720 and generates a counterfeit alert 724 (in this embodiment, in the form of an email or SMS message communicated to the user or users authorized to use the admin website portal that have set their preferences to provide a notification if there is a counterfeit detected) and displays 718 a counterfeit message 515 (FIG. 15) in the user interface of the mobile device 30 used to read the identifier.

The user 31 of the mobile device 30 displaying the counterfeit message 515 may select to enable the system 10 to identify the user's location 722, 516 (FIG. 15), which allows the system 10 to retrieve the exact geolocation coordinates from the mobile device 30, updating 726 the geolocation coordinates currently stored in the record 799 in the database 220. If so, the enable location 515 feature is removed 730 from the user interface and the flag indicating that the geolocation coordinates were obtained from the IP Address are set to false 731.

If the identifier 50 does match a verification record 350, the system 10 then checks whether the verification record 350 has a counterfeit flag 704, 396 indicating that the identifier is counterfeit. If the counterfeit flag exists, the mobile device 30 displays a counterfeit message 718 and the steps in the previous paragraph apply.

If the counterfeit flag does not exist, the system 10 communicates a success message along with an option to provide the exact location 706 to the mobile device interface 517 (FIG. 17). The user 31 of the mobile device 30 displaying the counterfeit message 517 may then select to enable the system 10 to identify the user's location 722, 516 (FIG. 15), which allows the system 10 to retrieve the exact geolocation coordinates from the mobile device 30, updating 710 the geolocation coordinates currently stored in the record 799 in the database 220. If this option is not selected, the interface remains unchanged (FIG. 17).

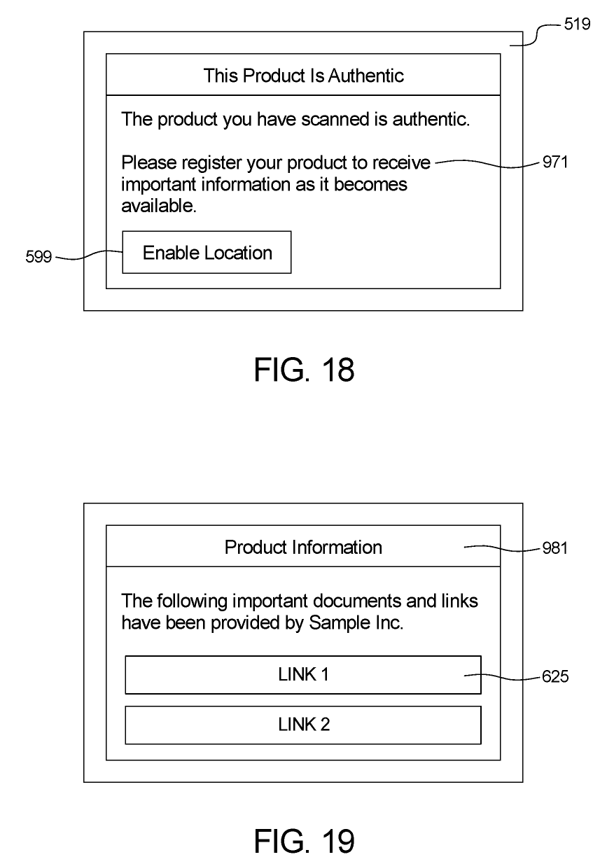

If the enable location 518 feature is selected, the system 10 passes information to remove the enable location feature 708 from the user interface and replace it with a register option 799 (FIG. 18), and the flag indicating that the geolocation coordinates were obtained from the IP Address is set to false 712. The system 10 then checks the device 30 to determine whether it has ever been used to retrieve information from the identifier 50, for example using browser cookies 714 in the determination.

If a browser cookie does not exist on the mobile device 30 indicating that the mobile device 30 was not previously used to retrieve information from the identifier 50, the system 10 generates a browser cookie 734 containing information indicating that the device 30 has been used to retrieve information from the identifier 50, and places the cookie on the mobile device 30. If a browser cookie indicating that the mobile device 30 was previously used to retrieve information from the identifier 50 does exist, the system 10 examines the cookie to determine whether the identifier has been previously scanned 716.

If the cookie indicates that the identifier 50 has been previously scanned by the mobile device 30, the system 10 replaces the provide location feature 742, 518 (FIG. 17) with a feature to register 744, 599 (FIG. 18) and the interface indicates that the product is authentic 519 (FIG. 18).

If a different unique identifier 50 (for example another product) has been previously scanned by the mobile device 30, but not the current identifier 50 (the product currently being scanned), system 10 updates the browser cookie 752 including information indicating that the device 30 has been used to retrieve information from the current identifier 50. In addition, along with the step where a cookie was created above, the system 10 next checks 738 the database 220 to determine whether any previous records 799 include the same information included in the identifier 50 scanned by the mobile device 30. This step checks to see whether any other device 30 has previously checked the same identifier 50. If not, the system 10 replaces the provide location feature 518 (FIG. 17) with a feature to register 599 (FIG. 18) and the interface indicates that the product is authentic 519 (FIG. 18).

If another device 30 has previously scanned the identifier 50, the geolocation coordinates of the current device 30 are compared 739 to those of any previous device 30 that checked the same identifier 50. The difference in geolocation coordinates produces a distance (measured, for example, in miles or kilometers). In some examples of the system 10, each company establishes a maximum distance (radius) that an identifier can move without returning a result that the identifier is counterfeit. If the distance between the geocoordinates is greater than the radius 740, the mobile device 30 displays a counterfeit message 718 and proceeds to step 720. If the distance between the geocoordinates is less than or equal to the radius 740, the system 10 replaces the provide location feature 742, 518 (FIG. 17) with a feature to register 744, 599 (FIG. 18) and the interface indicates that the product is authentic 519 (FIG. 18).

In the event that all the above steps result in the identifier being determined to be authentic 742, in response to activation of an add register button 744, the system 10 determines whether the identifier has been previously registered 748 by checking a registered flag 395 in the records 350 within the database 220. If it has, the register option is removed 746. If not, the register button remains 750 until the identifier is registered (if ever).

FIG. 5 is a flowchart illustrating the operation of the counterfeit detection and content management system 10 when the identifier 50 has not yet been activated. As shown in FIG. 5, in response to reading the identifier 700, when the identifier 50 is already located in a record within the database 220, the system 10 determines whether the identifier 50 has been previously activated 900 by the presence of an active flag 399 (FIG. 9) in the product verification records 350 (FIG. 9) stored in the database 220. When the active flag is set to true 901, the mobile device 30 displays an interface 901 indicating that the identifier 50 has been previously activated 450 (FIG. 13). When the active flag is set to false, the system 10 changes the flag to true and the mobile device 30 displays an interface 902 indicating that the identifier is now active 430 (FIG. 11).

FIG. 6 is a flowchart illustrating the operation of the counterfeit detection and content management system 10 to determine whether an information panel should be displayed when the identifier 50 is active. As shown in FIG. 6, in response to reading the identifier 700, when the identifier 50 is located within the database 220, the system 10 determines whether the identifier 50 is set up to display an information panel 950 by the presence of a display information flag 397 (FIG. 9) in the product verification records 350 (FIG. 9) stored in a database 220. When the display information flag is set to true 901, the mobile device 30 displays an interface 951 displaying product information 80 (FIG. 19). When the flag is set to false 952, no further action is taken.

FIG. 7 is a flowchart illustrating the operation of the counterfeit detection and content management system 10 to determine whether a service panel should be displayed when the identifier 50 is active. When an identifier 50 is located within the database 220, the system 10 determines whether the identifier 50 is set up to display a service panel 955 by the presence of a display service flag 398 (FIG. 9) in the product verification records 350 (FIG. 9) stored in a database 220. When the display service flag is set to true 956, the mobile device 30 displays an interface 951 displaying action items such as servicing and commissioning 82 (FIG. 16). When the flag is set to false 957, no further action is taken.

FIG. 8 illustrates the steps of generating the identifier 50 in an example of the counterfeit detection and content management system 10. First, at step 310, an organization provides product information, including the organization's name 380 (FIG. 9), a product number 391 (FIG. 9), and a unique serial number 393 (FIG. 9), for each identifier 50 that is to be created. At step 320, the product information is uploaded to the database 220 and the database stores the product information in product verification records 350.

In some embodiments, the counterfeit detection and content management system 10 may fill in any missing product information that was not received from the organization. For example, any missing product numbers 391 and/or serial numbers 393 may be assigned as necessary. This assignment may or may not be random (i.e., the same product number may be used for like products, and in this case a different serial number will be assigned to ensure the combination of organization, product number, and serial number are truly unique).

As shown in FIG. 8, after the information received from the organization is stored in the database 220, the system 10 generates a random parity check ID code 394 (FIG. 9). The parity check ID 394 is a completely random string of characters using the combination of alphanumeric characters in lower and capital casing. The parity check ID 394 is a randomly generated code and can be any length (e.g., a current embodiment utilizes three characters). The parity check ID 394 may be reused, however, in an embodiment, each product verification record 350 in the database 220 must be unique. Specifically, when creating product verification records 350, the counterfeit detection and content management system 10 may check to ensure that the combination of organization ID 360, product ID 390, serial ID 392, and parity check ID 394 is unique. The organization ID 360, product ID 390, serial ID 392, and parity check ID 394 collectively constitute a uniquely individual identifier 50.

Next, in step 340, the unique identifier 50 is reduced to a physical object. In the embodiment shown, this is a unique uniform resource locator (“URL”). The URL may include or reference the organization ID 360, product ID 390, serial ID 392, and parity check ID 394, or it may utilize an proxy or cryptic encoding for any or all of the above.

For example, a URL may be created such as the following: https://uprcode.com/products/[organization nameID]/[product number ID]/[serial numberID]/[parity check ID]. As shown, each of the organization ID 360, product ID 390, serial ID 392, and parity check ID 394 may be encoded in the URL using parameters. For example, a URL may be https://uprcode.com/products//1/1/1/h5t/, in which the organization ID 360 is 1 representing organization name 380 of Acme Corp., the product ID 390 is 1 representing the product number 391 of 97317, the serial ID 392 is 1 representing the serial number 393 of 579ce2, and the parity check ID 394 is h5t.

Once the URL is generated, in the next step, step 345, the URL may be incorporated into an identifier 50, such as a QR Code, bar code, or other physical rendering encoding information affixed to the end product, or may be an electronic identifier, such as an RFID chip, etc. For example, if the identifier 50 is a QR code, the QR code may be printed onto a product label to be distributed along with, or affixed to, the piece of the product associated with it (e.g., the identifier 50 may be printed onto product packaging or product itself).

FIG. 9 is a chart illustrating an example of a product verification record stored in the database 220 of the system 10. As shown in FIG. 9, in this example, the database 220 includes a product verification record 350 storing the values of the organization ID 360, the organization name 380, the product ID 390, the product number 391, the serial ID 392, the serial number 393, and the parity check ID 394. It also includes the display information flag 397, the display service flag 398, the active flag 399, the registered flag 395, and the counterfeit flag 396. As shown, a 1 indicates the presence of a flag and a 0 indicates the absence of a flag. Those skilled in the art will recognize the structure of the database 220 may be adapted in numerous ways while accomplishing the objectives of the system 10 described herein.

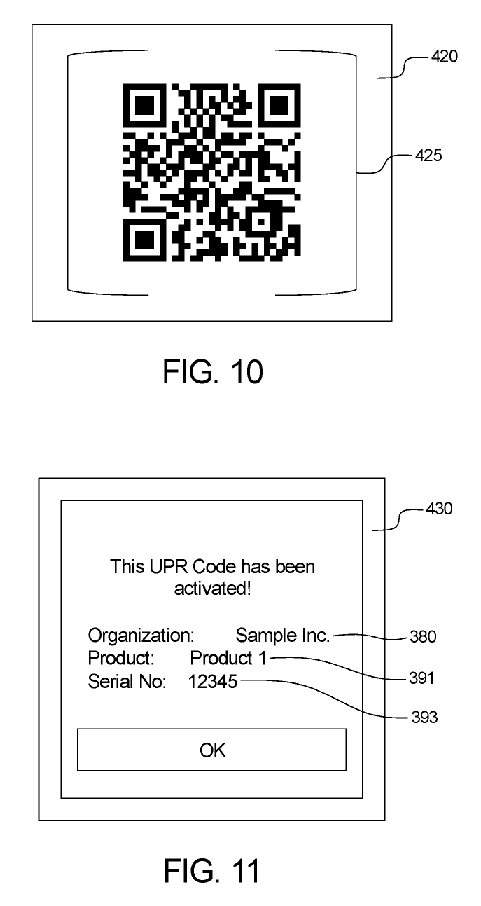

Turning to FIG. 10, in the example shown, a mobile device 30 displays a scanning screen 420 which is used to retrieve information from the identifier 50. In the embodiment shown, the scanning screen 420 is adapted to scan a QR code. In other embodiments, the scanning screen 420 may be adapted to scan bar codes, RFID chips, etc. The scanning screen 420 may include a scanner 425 to permit the mobile device 30 to scan the identifier 50. In the embodiment shown, the scanner 425 is a camera view that displays the view from a camera subsystem 116. The mobile device 30 may be positioned such that the identifier 50 is directly in view of the scanner 425. The counterfeit detection application may then detect the identifier 50 and decode the authentication information. The authentication information may then be sent to the counterfeit detection and content management servers 20 for verification.

FIG. 11 illustrates an example of a product activation screen 430 that is displayed when the identifier 50 is correctly activated. In the example shown, the product activation screen 430 confirms the organization's name 380, the product number 391, and the unique serial number 393 of the identifier 50.

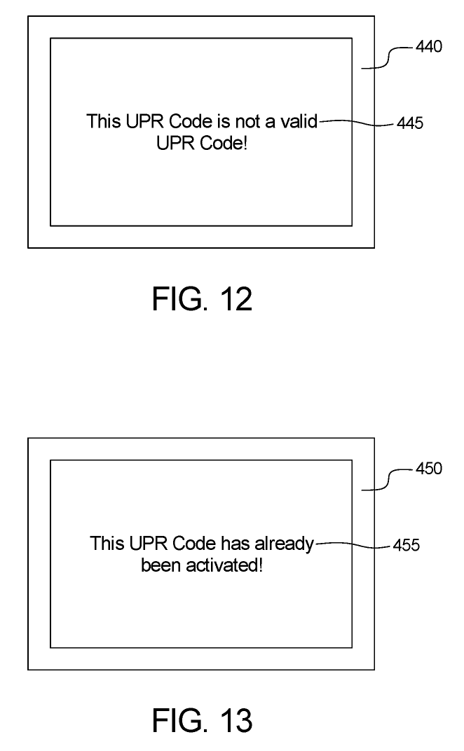

FIG. 12 illustrates a failed scan screen 440. In the event that a scanned identifier 50 does not exist in the database 220, the failed scan screen may be displayed and may include a warning message 445. A failed scan may occur for a number of reasons including, but not limited to: (a) an issue with the printing of the identifier 50, (b) an identifier 50 that was generated with improper syntax, or (c) a counterfeit identifier 50.

As shown in FIG. 13, in an embodiment, in the event that an identifier 50 was previously activated in the database 220, a previous activation screen 450 including a warning message 455 may appear. A duplicate activation scan may occur for a number of reasons including, but not limited to when an identifier 50 has been generated twice. As discussed above, identifiers 50 are designed to be unique to an organization, product and serial number. With this in mind, a duplicate scan may indicate that the identifier 50 has been copied onto the product label and may be a sign of a counterfeit identifier 50.

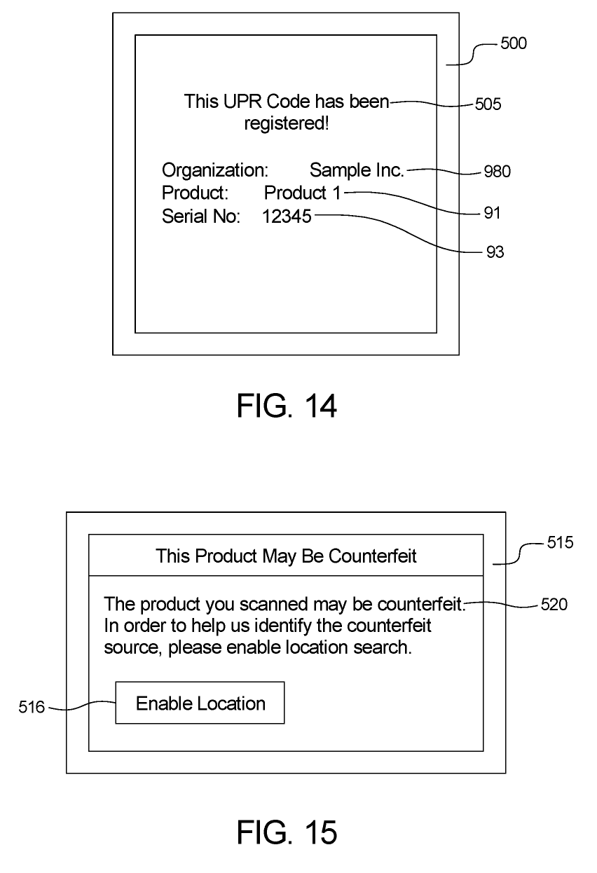

FIG. 14 illustrates an example product registration confirmation screen 500 that may be displayed upon a successful registration scan. As shown, the example product registration confirmation screen may include a confirmation message 505 confirming successful registration and displaying the organization name 380, product number 391, and serial number 393.

Turning to FIG. 15, in an embodiment, in the event that a scanned identifier 50 is counterfeit (as discussed with reference to FIG. 4), an alert screen 515 including a warning message 520 is displayed. As shown, the alert screen 515 may include a button 516 to provide geolocation coordinates to the system 10 from the mobile device 30.

As shown in FIG. 16, in an embodiment, when a scanned identifier 50 is valid and has been previously registered within the counterfeit detection and content management system 10, the mobile device 30 may display additional features such as a screen providing options to service the product 82. For example, the options may include an option to install the product 532, an option to service the product 534, an option to repair the product 536, an option to decommission or remove the product 538, and an option to view the service history of the product 540.

Turning to FIG. 17, in the example shown, in the event that a scanned identifier 50 may be authentic (as discussed with reference to FIG. 4), an alert screen 517 including a geolocation request message 970 is displayed. As shown, the alert screen 517 may include a button 518 to provide geolocation coordinates to the system 10 from the mobile device 30.

Turning to FIG. 18, in the example shown, in the event that a scanned identifier 50 is authentic (as discussed with reference to FIG. 4), a registration request screen 519 including a message 971 is displayed. The registration request screen 519 may include a button 599 to register the product.

Turning to FIG. 19, an example of a product information screen 981 is shown. In the example shown, in the event that a scanned identifier 50 is authentic (as discussed with reference to FIG. 4), product literature for the identifier 50 using a product information screen 981 is displayed. Product literature may include reference literature, such as service manuals, user guides, video recordings, etc. The user 31 may follow hyperlinks 625 on the product information screen 981 to access the provided information.

Turning to FIG. 20, an example of a product recall screen 982 is shown. In the example shown, in the event that a scanned identifier 50 is authentic (as discussed with reference to FIG. 4), the product recall screen 982 including a recall message 983 is displayed.

Turning to FIG. 21, an example of a service bulletin screen 982 is shown. In the example shown, in the event that a scanned identifier 50 is authentic (as discussed with reference to FIG. 4), a service bulletin screen 982 including a message 983 is displayed.

Referring back to FIG. 2, the user device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 30 is intended to operate. For example, the user device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 44. The memory 44 can include high-speed random access memory and/or non-volatile memory, such as one or more magnetic disk storage devices, one or more optical storage devices, and/or flash memory (e.g., NAND, NOR). The memory 44 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 44 may also store communication instructions 142 to facilitate communicating with one or more additional devices, one or more computers and/or one or more servers. The memory 44 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 44 may also store other software instructions controlling other processes and functions of the user device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 44.

Each of the above identified instructions and applications can correspond to a set of instructions for performing one or more functions described herein. These instructions need not be implemented as separate software programs, procedures, or modules. The memory 44 can include additional instructions or fewer instructions. Furthermore, various functions of the user device 30 may be implemented in hardware and/or in software, including in one or more signal processing and/or application specific integrated circuits. Accordingly, the user device 30, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a mobile device-type implementation, those skilled in the art will recognize that the one or more controllers 103 also encompasses systems such as host computers, servers, workstations, network terminals, PCs and the like. Further one or more controllers 103 may be embodied in a user device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A counterfeit product detection and content management system comprising:
a physical identifier affixed to a product, the physical identifier including an organization identifier, a product identifier, a serial identifier, and a parity check identifier;
a mobile device including a physical identifier reader and a communications subsystem; and
a server in communication with the mobile device and in communication with a database storing a plurality of product verification records, each product verification record including a stored organization identifier, a stored product identifier, a stored serial identifier, and a stored parity check identifier;
wherein, in response to the server receiving a communication of the physical identifier from the mobile device, the server determines whether the organization identifier, the product identifier, the serial identifier, and the parity check identifier match the stored organization identifier, the stored product identifier, the stored serial identifier, and the stored parity check identifier of one of the stored product verification records in the database and, when the server determines there is no match, the server communicates to the mobile device that the product is counterfeit.

2. The system of claim 1 wherein the physical identifier is encoded in a URL.

3. The system of claim 2 wherein the URL is encoded in one of a QR code, a bar code, and an RFID chip.

4. The system of claim 3 wherein the URL includes the organization identifier, the product identifier, the serial identifier, and the parity check identifier.

5. The system of claim 1 wherein at least one of the product verification records further includes a date and a time that the physical identifier was communicated to the server, and an IP address of the mobile device at the time the physical identifier was communicated to the server.

6. The system of claim 1 wherein, when the server determines there is a match, the server determines if the matched product verification record includes a counterfeit flag.

7. The system of claim 6 wherein, when the server determines there is a counterfeit flag, the server communicates to the mobile device that the product is counterfeit.

8. The system of claim 6 wherein, when the server determines there is no counterfeit flag, the server communicates to the mobile device that the product may be authentic.

9. The system of claim 8 wherein, the server requests geolocation coordinates of the mobile device at the time the physical identifier is communicated to the server, and if allowed, updates geolocation coordinates in the matched one of the stored product verification records.

10. The system of claim 9 wherein when the server determines the physical identifier has previously been communicated to the server, the server communicates to the mobile device that the product is authentic.

11. The system of claim 9 wherein when the server determines the physical identifier has previously been communicated to the server by any mobile device, the server determines whether the physical identifier has previously been communicated to the server by the same mobile device.

12. The system of claim 11 wherein when the server determines that the physical identifier has been previously communicated by the mobile device, the server communicates to the mobile device that the product is authentic.

13. The system of claim 11 wherein when the server determines that the physical identifier has not been previously communicated to by the same mobile device, the server compares the geolocation coordinates being communicated to the server to any previously stored product verification records for the physical identifier and, if a distance between geolocation coordinates in the stored product verification record and the geolocation coordinates being communicated to the server are greater than a predetermined allowable distance, the server communicates to the mobile device that the product is counterfeit.

14. The system of claim 11 wherein when the server determines that the physical identifier has not been previously communicated to by the same mobile device, the server compares the geolocation coordinates being communicated to the server to any previously stored product verification records for the physical identifier and, if a distance between geolocation coordinates in the stored product verification record and the geolocation coordinates being communicated to the server are less than or equal to a predetermined allowable distance, the server communicates to the mobile device that the product is authentic.

15. The system of claim 11 wherein the server determines the physical identifier has not been previously communicated to the server, the server communicates to the mobile device that the product is authentic.

16. The system of claim 1 wherein the parity check identifier is a randomly generated string of characters.

17. A counterfeit product detection and content management method comprising the steps of:
affixing a physical identifier to a product, the physical identifier including an organization identifier, a product identifier, a serial identifier, and a parity check identifier;
providing a mobile device including a physical identifier reader and a communications subsystem; and
providing a server in communication with the mobile device and in communication with a database storing a plurality of product verification records, each product verification record including a stored organization identifier, a stored product identifier, a stored serial identifier, and a stored parity check identifier;
wherein, in response to the server receiving a communication of the physical identifier from the mobile device, the server determines whether the organization identifier, the product identifier, the serial identifier, and the parity check identifier match the stored organization identifier, the stored product identifier, the stored serial identifier, and the stored parity check identifier of one of the stored product verification records in the database and, when the server determines there is no match, the server communicates to the mobile device that the product is counterfeit.

18. The method of claim 17 wherein the physical identifier is encoded in a URL.

19. The method of claim 18 wherein the URL is encoded in one of a QR code, a bar code, and an RFID chip.

20. The method of claim 19 wherein the URL includes the organization identifier, the product identifier, the serial identifier, and the parity check identifier.
